(19) United States
(12) Patent Application Publication
(10) Pub. No.: US 2019/0293607 A1
(43) Pub. Date: Sep. 26, 2019

(54) MEASURING AN OUTER ZONE OF A CONCRETE FOUNDATION ELEMENT

(71) Applicant: Piletest.com Ltdy, Herzlia (IL)

(72) Inventors: Joram Amir, Herzlia (IL); Erez Amir, Even-Yehuda (IL)

(21) Appl. No.: 16/358,732

(22) Filed: Mar. 20, 2019

Related U.S. Application Data
(60) Provisional application No. 62/645,817, filed on Mar. 21, 2018.

(51) Int. Cl. G01N 29/06; G01N 29/12; G01N 29/04; G01N 29/34

(52) U.S. Cl. CPC G01N 29/06; G01N 29/34; G01N 29/043; G01N 29/12

(57) ABSTRACT

A method, system and a computer readable medium. The method may include (a) transmitting, by an ultrasonic probe, one or more transmitted ultrasonic pulses towards an edge of the outer zone; wherein the transmission occurs while the ultrasonic probe is located in a hole that is proximate to a reinforcement cage of the concrete foundation element, (b) receiving, by the ultrasonic probe, one or more ultrasonic echoes that were reflected from the region of the edge of the outer zone and passed less than twice through the reinforcement cage, and (c) determining a distance between the reinforcement cage and the region of the edge.

### CROSS REFERENCE

This application claims priority from U.S. provisional patent 62/645,817, filing date Mar. 21, 2018.

### BACKGROUND

Deep foundation elements, such as drilled shafts, bored piles and barrettes, are invariably cast into a hole in the ground and thus are prone to construction defects. Most of such defects are found in the outer zone of the deep foundation element, the outer zone (also referred to as a concrete cover) is located outside of a reinforcement cage since this is where the concrete rising in the excavation during casting is resisted by the reinforcement cage, surrounding soil and groundwater.

FIG. 1 is an example of a defective concrete foundation element 11 and a proper concrete foundation element 11′. The proper concrete foundation element 11′ has a cylindrical exterior and the reinforcement cage is buried by the concrete cover. The defective concrete foundation element 11 has an irregular exterior and many parts of the reinforcement cage are exposed.

### SUMMARY

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description may be not limited to the disclosed embodiments and examples.

There may be provided a method for measuring an outer zone of a concrete foundation element, the method may include transmitting, by an ultrasonic probe, one or more transmitted ultrasonic pulses towards an edge of the outer zone; wherein the transmission occurs while the ultrasonic probe is located in a hole that is proximate to a reinforcement cage of the concrete foundation element; receiving, by the ultrasonic probe, one or more ultrasonic echoes that were reflected from the region of the edge of the outer zone and passed less than twice through the reinforcement cage; and determining a distance between the reinforcement cage and the region of the edge; wherein the determining is based on a spatial relationship between the reinforcement cage and the ultrasonic probe, and timing relationships between the one or more transmitted ultrasonic pulses and the one or more ultrasonic echoes.

There may be provided a method for measuring an outer zone of a concrete foundation element, the method may include transmitting, by an ultrasonic probe, one or more transmitted ultrasonic pulses, directed outside a reinforcement cage of the concrete foundation element and towards an edge of the outer zone; wherein the transmission occurs while the ultrasonic probe is located in a hole that is located within the reinforcement cage; receiving, by the ultrasonic probe, one or more ultrasonic echoes that were reflected from the region of the edge of the outer zone; and determining a distance between the reinforcement cage and the region of the edge; wherein the determining is based on a spatial relationship between the reinforcement cage and the ultrasonic probe, and timing relationships between the one or more transmitted ultrasonic pulses and the one or more ultrasonic echoes.

There may be provided a method for measuring an outer zone of a concrete foundation element, the method may include transmitting, by an ultrasonic probe, one or more transmitted ultrasonic pulses towards a region of an edge of the outer zone; wherein the transmission occurs while the ultrasonic probe is located in a hole that is closer to the region of the edge than to a center of the concrete foundation element; receiving, by the ultrasonic probe, one or more ultrasonic echoes that were reflected from the region of the edge of the outer zone; and determining a distance between a reinforcement cage of the concrete foundation element and the region of the edge; wherein the determining is based on a spatial relationship between the reinforcement cage and the ultrasonic probe, and timing relationships between the one or more transmitted ultrasonic pulses and the one or more ultrasonic echoes.

There may be provided a non-transitory computer readable medium for measuring an outer zone of a concrete foundation element, the non-transitory computer readable medium may store instructions for: transmitting, by an ultrasonic probe, one or more transmitted ultrasonic pulses towards a region of an edge of the outer zone; wherein the transmission occurs while the ultrasonic probe is located in a hole that is closer to the region of the edge than to a center of the concrete foundation element; receiving, by the ultrasonic probe, one or more ultrasonic echoes that were reflected from the region of the edge of the outer zone; and determining a distance between a reinforcement cage of the concrete foundation element and the region of the edge; wherein the determining is based on a spatial relationship between the reinforcement cage and the ultrasonic probe, and timing relationships between the one or more transmitted ultrasonic pulses and the one or more ultrasonic echoes.

There may be provided a non-transitory computer readable medium for measuring an outer zone of a concrete foundation element, the non-transitory computer readable medium may store instructions for transmitting, by an ultrasonic probe, one or more transmitted ultrasonic pulses, directed outside a reinforcement cage of the concrete foundation element and towards an edge of the outer zone; wherein the transmission occurs while the ultrasonic probe is located in a hole that is located within the reinforcement cage; receiving, by the ultrasonic probe, one or more ultrasonic echoes that were reflected from the region of the edge of the outer zone; and determining a distance between the reinforcement cage and the region of the edge; wherein the determining is based on a spatial relationship between the reinforcement cage and the ultrasonic probe, and timing relationships between the one or more transmitted ultrasonic pulses and the one or more ultrasonic echoes.

There may be provided a non-transitory computer readable medium for measuring an outer zone of a concrete foundation element, the non-transitory computer readable medium may store instructions for transmitting, by an ultrasonic probe, one or more transmitted ultrasonic pulses towards an edge of the outer zone; wherein the transmission occurs while the ultrasonic probe is located in a hole that is proximate to a reinforcement cage of the concrete foundation element; receiving, by the ultrasonic probe, one or more ultrasonic echoes that were reflected from the region of the edge of the outer zone and passed less than twice through the reinforcement cage; and determining a distance between the reinforcement cage and the region of the edge; wherein the determining is based on a spatial relationship between the reinforcement cage and the ultrasonic probe, and timing relationships between the one or more transmitted ultrasonic pulses and the one or more ultrasonic echoes.

There may be provided a system that includes a processor and an ultrasonic probe that comprises an ultrasonic transmitter and an ultrasonic receiver; wherein the ultrasonic probe is configured to transmit one or more transmitted ultrasonic pulses towards a region of an edge of the outer zone; wherein the transmission occurs while the ultrasonic probe is located in a hole that is closer to the region of the edge than to a center of the concrete foundation element; wherein the ultrasonic probe is configured to receive one or more ultrasonic echoes that were reflected from the region of the edge of the outer zone; and wherein the processor is configured to participate in determining a distance between a reinforcement cage of the concrete foundation element and the region of the edge; wherein the determining is based on a spatial relationship between the reinforcement cage and the ultrasonic probe, and timing relationships between the one or more transmitted ultrasonic pulses and the one or more ultrasonic echoes. The processor may belong to the ultrasonic probe or may not belong to the ultrasonic probe. The determining may be execute solely by the processor or partially by the processor and partially by the ultrasonic probe.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a defective concrete foundation element and a proper concrete foundation element;

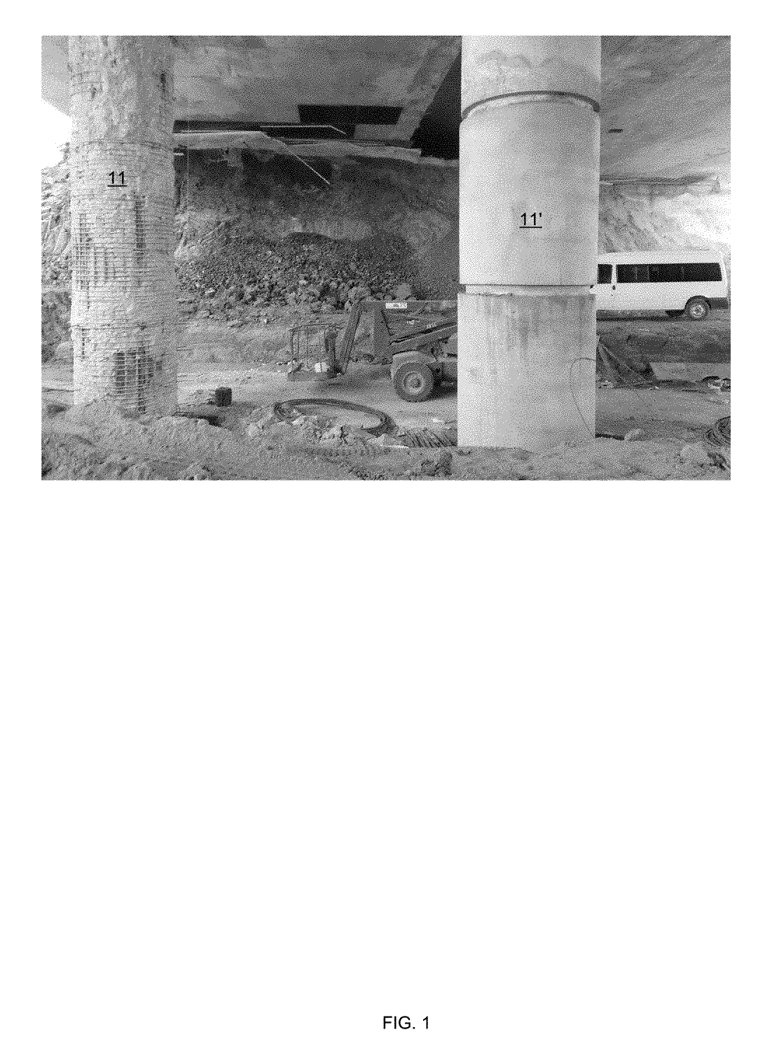

FIG. 2 is a top view illustrating an example of a concrete foundation element and ultrasonic probes;

FIG. 3 is an example of a part of a concrete foundation element, an ultrasonic probe and ultrasonic signals;

FIG. 4 is a cross sectional view illustrating an example of a concrete foundation element and ultrasonic probes;

FIG. 5 is an example of a transmitted ultrasonic pulse and of an ultrasonic echo;

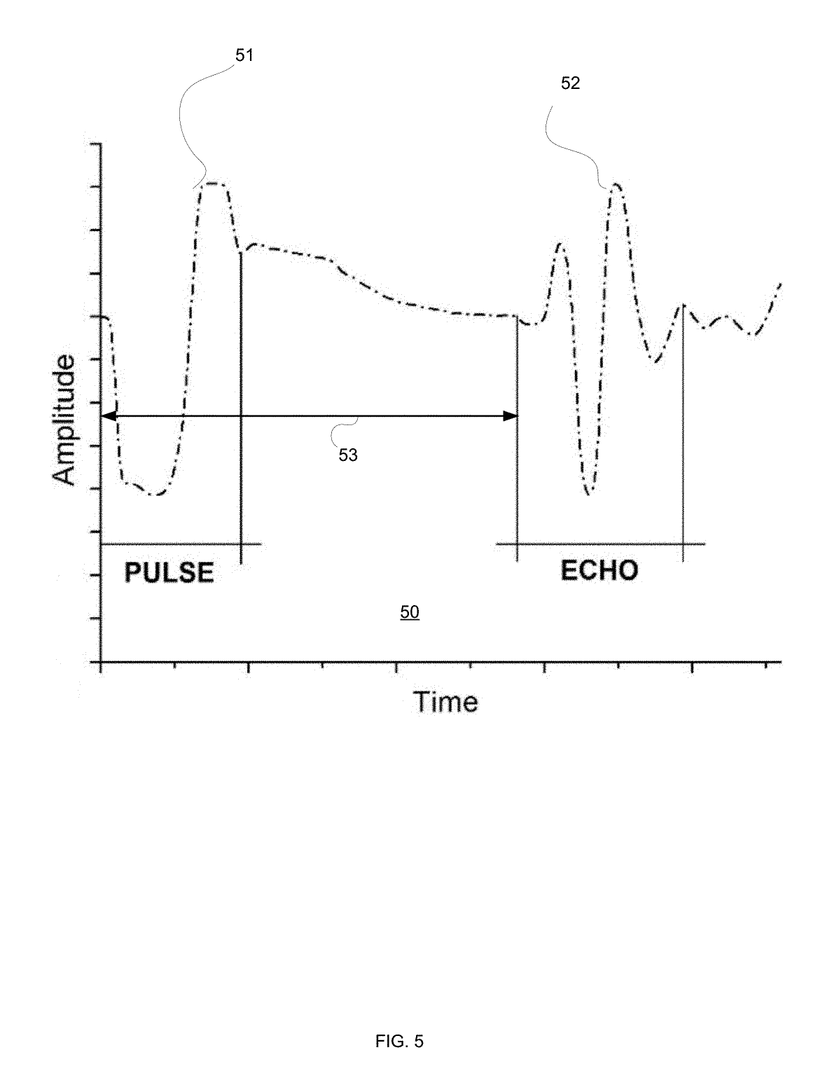

FIG. 6 is an example of an estimate of a thickness of an outer zone based on measurements taken at different heights;

FIG. 7 is an example of a three dimensional model of the concrete foundation element that is based on multiple thickness measurements taken at different heights and at different angles;

FIG. 8 is an example of a part of a concrete foundation element, an ultrasonic probe and ultrasonic signals;

FIG. 9 is an example of a method;

FIG. 10 is a top view illustrating an example of a concrete foundation element and ultrasonic probes.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The method may determine the thickness based on a transmission of ultrasound signals by an ultrasonic probe that is proximate to the outer zone. The probe may be located within a hole (for example—a hole defined by a conduit such as an access tube) that is proximate to the outer zone. This proximity guarantees that the transmission path and the reception path of the of the ultrasonic signals are short (for example few centimeters), which enables a transmission of high frequency ultrasonic signals. The transmission of high frequency ultrasonic signals guarantee that the thickness measurement is of high resolution. Furthermore—the short transmission path and the reception path also reduce the chances that the ultrasonic signals will be scattered and propagate along a path that differs from a substantial direct path towards the edge of the outer zone.

For example—the diameter of a typical concrete foundation element is more than a meter (for example about 1.5 m). The thickness of the outer zone is usually few centimeters (for example—between 5 and 10 centimeters). Low frequency ultrasonic signals of up to 100 kHz propagate within concrete at speed of about 4400 m/s and are of a wavelength of 4.4 cm—which is inadequate for measuring the thickness of the outer zone in a reliable manner. On the other hand, the transmission of high frequency ultrasonic signals of about 300 kHz will result in a wavelength of about 1.5 cm.

The conduit may be attached to the reinforcement cage or be otherwise mechanically coupled to the reinforcement cage. The conduit may be positioned within the reinforcement cage, outside the reinforcement cage, and the like. The attachment of the conduit to the reinforcement cage can be easily implemented and in this position does not complicate (or even prevent) the casting of concrete into the hole formed in the ground.

There may be provided multiple conduits, for example—between 3-10, more than ten, and the like. Multiple conduits enable to perform thickness measurements at different locations.

The ultrasonic probe may be used to measure the thickness at different heights—by lowering and/or elevating the probe within the hole.

The conduit can be used for other measurements—such as but not limited to cross-hole ultrasonic (CSL) measurements that are conducted at a low frequency and measure the zone between different conduits. While the thickness measurement of the outer zone requires high-frequency ultrasonic signals, the CSL require low frequency ultrasonic signals that may propagate over longer distances.

An ultrasonic probe capable of operating in both a high-frequency ultrasonic range and low-frequency ultrasonic range and can transmit the ultrasonic signals over the short paths towards the edge of the external zone and both towards other conduits may assist in performing both CSL measurements and thickness measurement of the outer zone.

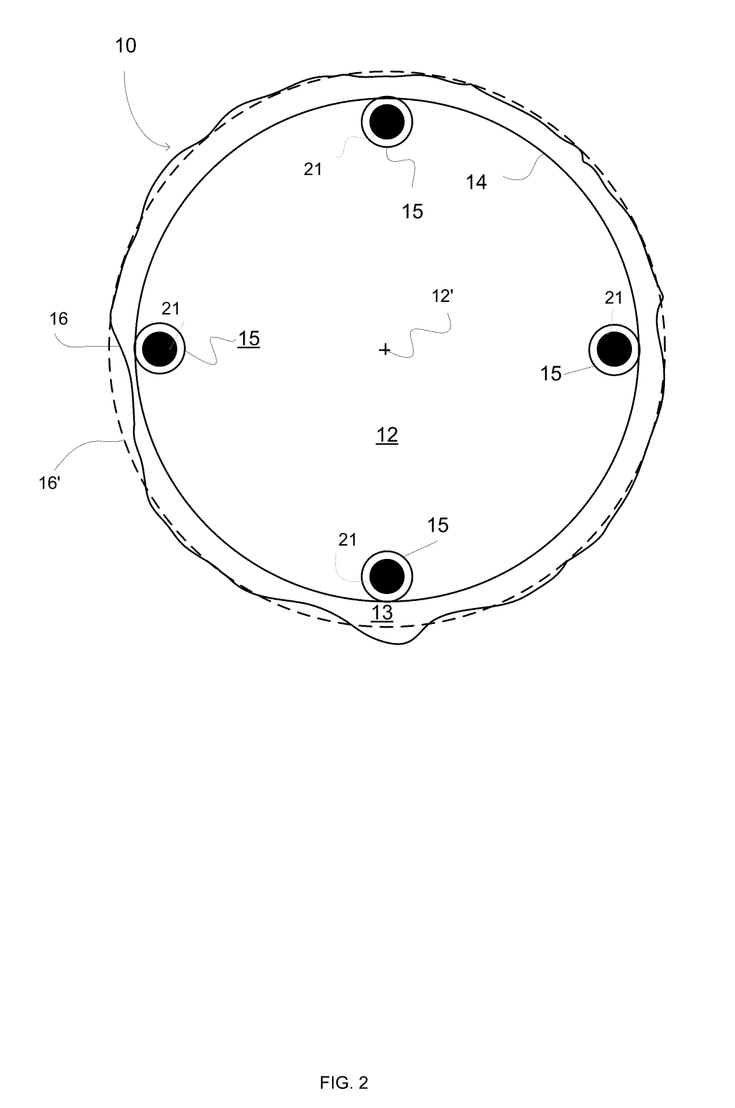

FIG. 2 is a top view illustrating an example of a concrete foundation element and ultrasonic probes. Dashed curve 16′ illustrates an ideal cylindrical exterior while curve 16 illustrates an actual exterior of concrete foundation element 12. The ultrasonic probes 21 may move within access tubes 15. The access tubes may be filled with fluid (such as water) and the ultrasonic probe may move within the fluid. The ultrasonic probes 21 are much closer to the exterior of the concrete foundation element 12 than to the center 12′ of the concrete foundation element 12.

In FIG. 2 the ultrasonic probes 21 are surrounded by the reinforcement cage 14 and are connected to the reinforcement cage 14. Other spatial and/or mechanical relationships may be provided.

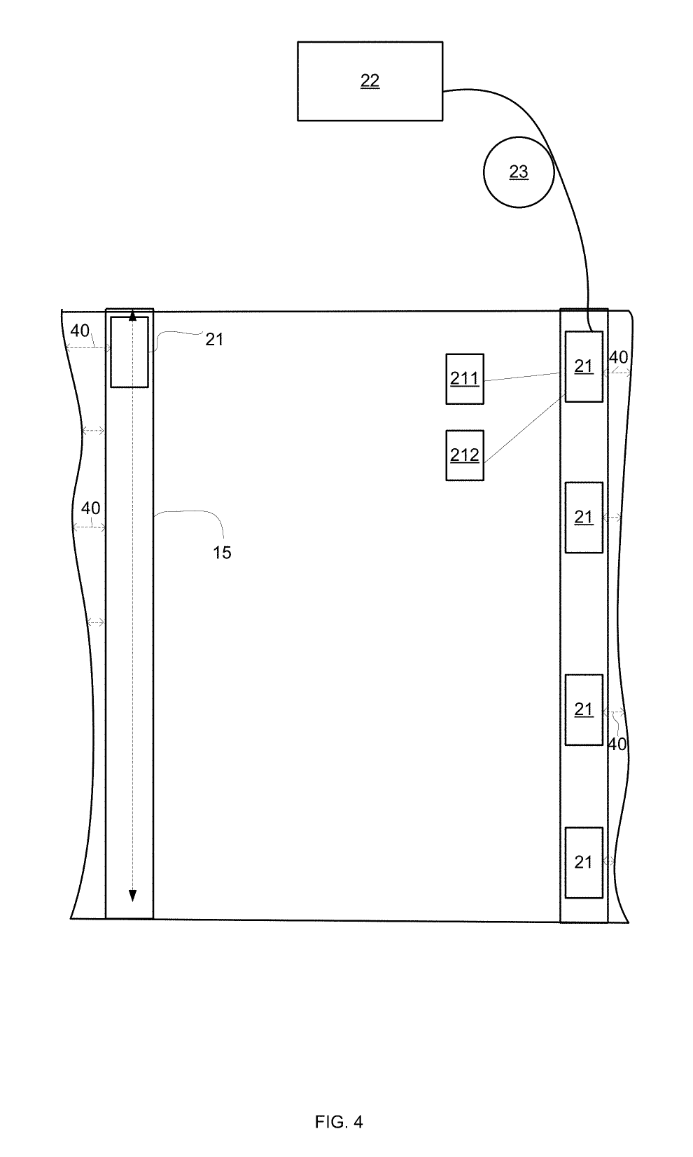

FIG. 4 illustrates four access tubes 15—although any other number of access tubes 15 may be provided. Furthermore—any other spatial relationship between the access tubes 15 may be provided. For example—the access tubes may be arranged in an asymmetrical manner.

Each ultrasonic probe 21 may include a transmitter 211 and a receiver 212. The transmitter and receiver may be proximate to each other (up to few centimeters apart from each other)—but may also be more distance from each other.

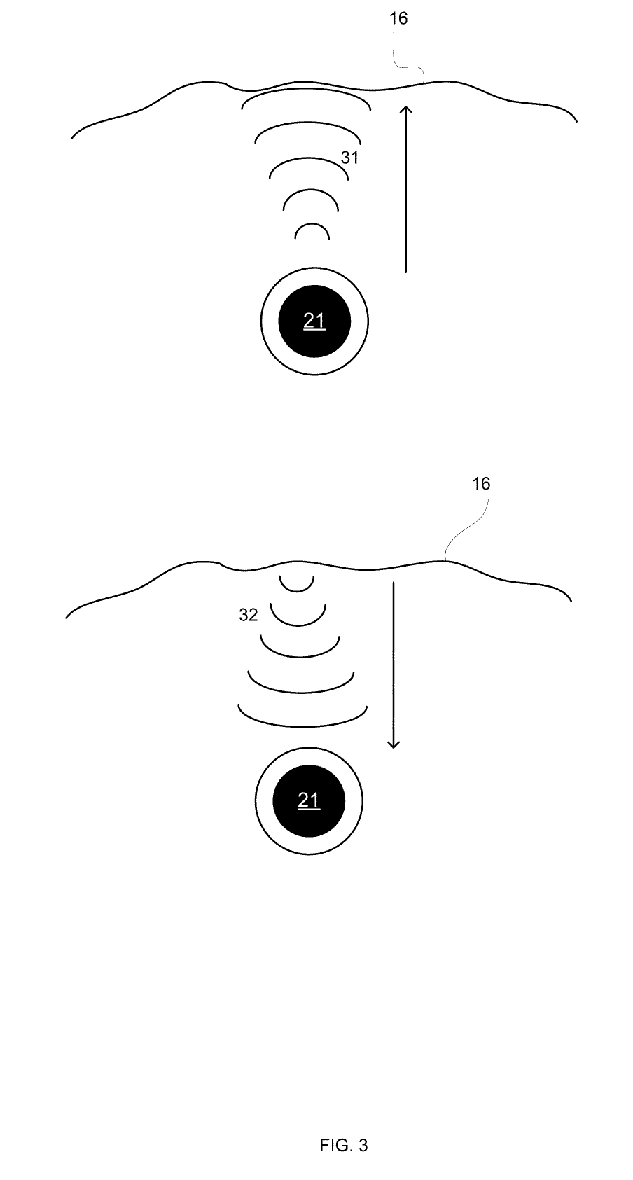

FIG. 3 is an example of a part of a concrete foundation element, an ultrasonic probe 21 and ultrasonic signals.

FIG. 3 illustrates transmitted ultrasonic signals 31 that are transmitted from the ultrasonic probe 21 outwards—towards the edge 16 of the outer zone.

FIG. 3 also illustrates received ultrasonic echoes 32 that are reflected from the edge 16 of the outer zone towards the ultrasonic probe 21.

It should be noted that the ultrasonic probe may transmit the ultrasonic signals at additional other directions (even may transmit a unidirectional signal)—but the ultrasonic echoes reflected from the edge that is proximate to the ultrasonic probe 21 will be received first and will probably have a higher intensity—as they undergo less attenuation in relation to ultrasonic echoes that undergo much longer paths.

FIG. 4 is a cross sectional view illustrating an example of a concrete foundation element and ultrasonic probes.

FIG. 4 illustrates various locations of the ultrasonic probes 21 within access tubes 15. The ultrasonic probes 21 may perform a thickness measurement 40 from almost each depth (height) within the access tube.

FIG. 4 also illustrates a processor 22 that may analyze detection signals and/or processed detection signals from the ultrasonic probe, may determine the thickness at different locations and may provide information regarding the concrete foundation element 12 based on the signals. The detection signals may represent the received ultrasonic echoes (see, for example signal 52 of FIG. 4), may be timing information regarding a time difference between a time of transmission of an ultrasonic signal and a time of reception of one or more ultrasonic echoes resulting from a transmission of the ultrasonic signal, may be thickness information, and the like. An example of a timing difference 53 is illustrated in graph 50—and represents the time difference between a transmission of pulse 51 and a reception of the ultrasonic echo 52.

There may be any allocation of processing tasks between processor 22 and the ultrasonic probe 21.

The processor 22 may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The ultrasonic probe 21 may exchange information with the processor in a wireless or wired manner. The ultrasonic probe 21 may be mechanically coupled to a cable that may be used to elevate or lower the ultrasonic probe (controlled by elevation/lowering unit 23) within the access tube. Alternatively—the ultrasonic probe may be self-propelled (even without mechanical coupling to unit 23) and its movement within the access tube may be remotely controlled.

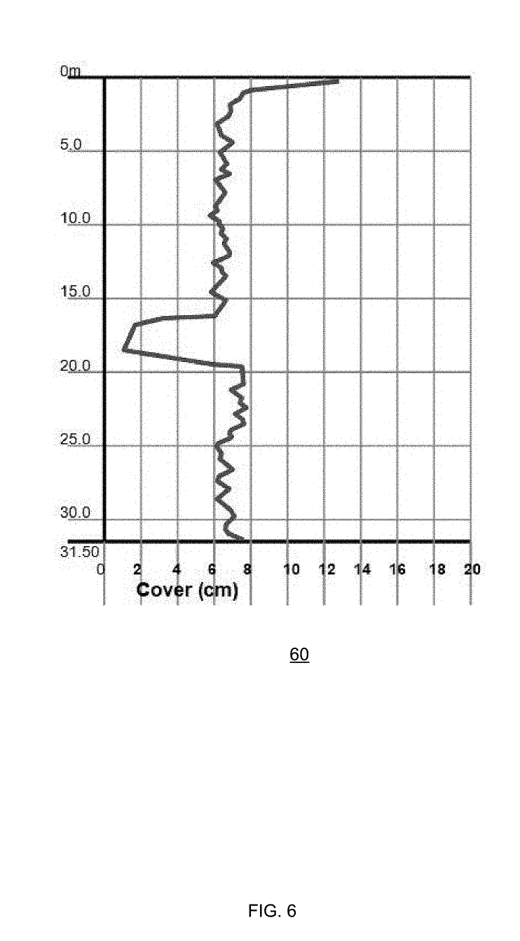

FIG. 6 is an example of an estimate 60 of a thickness of an outer zone based on measurements taken at different heights. The estimate is based on multiple thickness measurements taken at different depths.

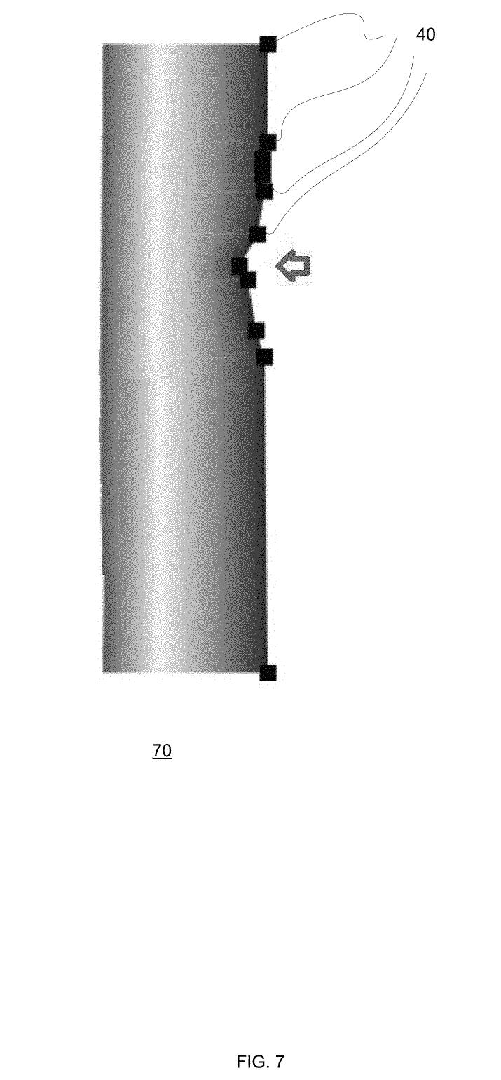

FIG. 7 is an example of a three-dimensional model 70 of the concrete foundation element that is based on multiple thickness measurements 40 taken at different heights and at different angles.

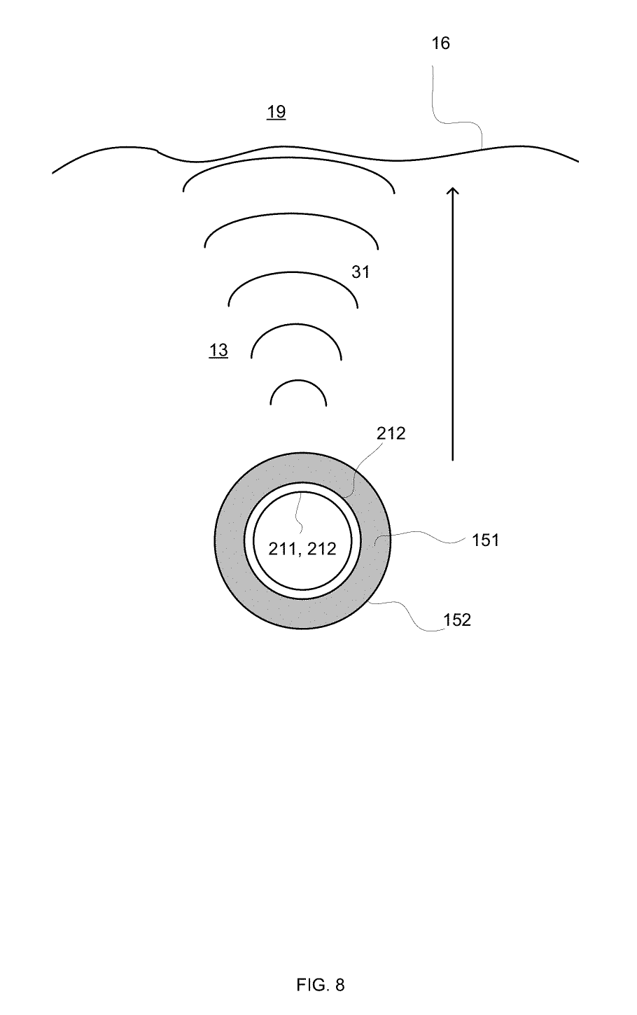

FIG. 8 is an example of a part of a concrete foundation element, an ultrasonic probe and ultrasonic signals.

FIG. 8 illustrates a reception and a transmission paths—and especially the difference elements that the ultrasonic signal and the ultrasonic echo has to pass. Regarding the transmission path—it starts from the transmitter 211 and/or receiver 212 of the ultrasonic probe 21, followed by the cover 212 of the ultrasonic probe 21, a fluid (such as water) 151 that fills the access tube, the sidewall 151 of the access tube, the outer zone 12, the edge of the outer zone. The edge interfaces with the ground 19.

These different media may affect the ultrasonic signal and the ultrasonic echo—and should be taken into account.

A learning process or a model may provide the mapping between the thickness and a property of the received ultrasonic echo. The mapping may be provided in any other manner.

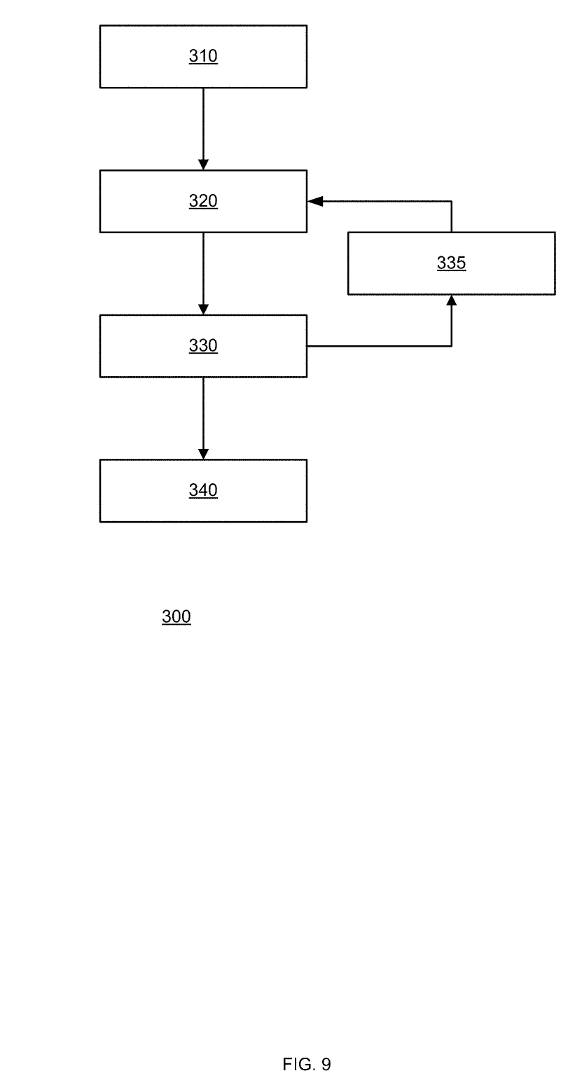

FIG. 9 is an example of a method 300.

Method 300 is for measuring an outer zone of a concrete foundation element.

Method 300 may start by step 310 of positioning an ultrasonic probe within a position within a hole that is formed within the concrete foundation element.

The hole may be delimited by a conduit.

The conduit may be located inside a reinforcement cage of the concrete foundation element, may be located outside the reinforcement cage, may be aligned with the reinforcement cage, may be mechanically coupled to the reinforcement cage, may be proximate (for example within less than 30 or 20 or 10 or 5 centimeters) to the reinforcement cage, may be located much closer to the edge of the concrete foundation element than to the center of the concrete foundation element, and the like.

Step 310 may be followed by step 320 of transmitting, by the ultrasonic probe, one or more transmitted ultrasonic pulses towards region of an edge of the outer zone. The region may be a fraction of the edge of the outer zone.

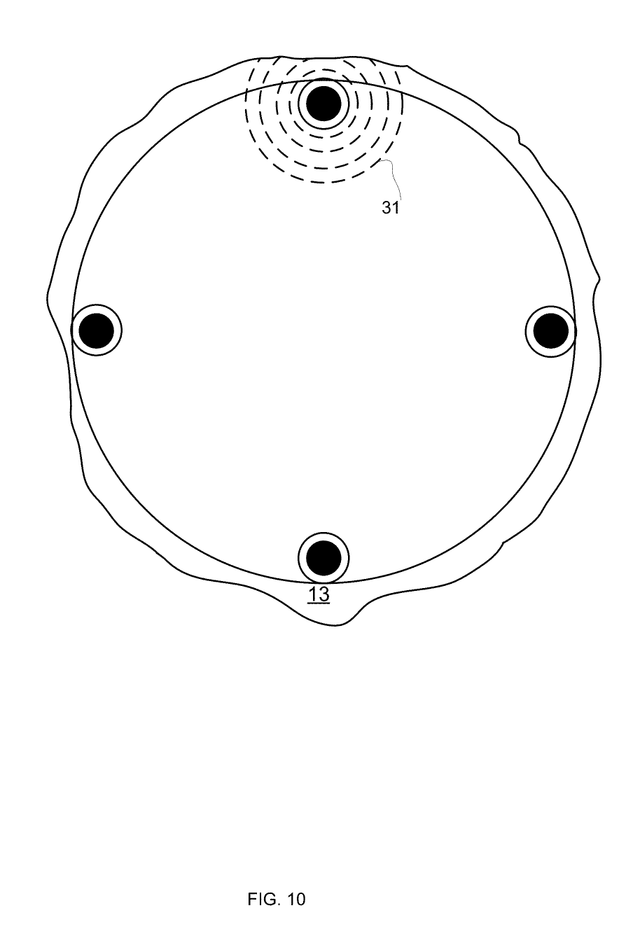

Step 320 may be limited to transmitting the one or more transmitted ultrasonic pulses towards the region—but step 320 may include transmitting the one or more ultrasonic pulses outside the region. For example—the one or more transmitted ultrasonic pulses may be omnidirectional (see, for example omnidirectional ultrasonic pulses 31 of FIG. 10) or directional.

Step 320 may be followed by step 330 of receiving, by the ultrasonic probe, one or more ultrasonic echoes that were reflected from the region of the edge of the outer zone. The receiving may include taking into account ultrasonic echoes received in a time window that may be tailored to fit the expected thickness of the the outer zone and may include ignoring ultrasonic echoes outside the time window.

If step 330 included transmitting one or more ultrasonic pulses outside the region then the ultrasonic probe may receive ultrasonic echoes reflected outside the region. Nevertheless—it is expected that that an ultrasonic echo from a point in the region that is closest to the ultrasonic probe will be the first ultrasonic echo to reach the the ultrasonic probe and will also be the strongest one. Thus—ultrasonic echoes from parts of the edge that are further away from the ultrasonic probe may arrive much later and be much weaker—and can be ignored of.

Furthermore—it is also expected that when the one or more transmitted ultrasonic pulses are of high frequency—they will be highly attenuated over large distances and may even not reach the more distant parts of the edge of the concrete foundation element.

Step 330 may be followed by step 340 of determining a distance between a reinforcement cage of the concrete foundation element and the region of the edge. This distance reflects the thickness of the outer zone.

The determining is based on a spatial relationship between the reinforcement cage and the ultrasonic probe, and timing relationships between the one or more transmitted ultrasonic pulses and the one or more ultrasonic echoes.

The spatial relationship may mean the distance between the reinforcement cage (that is regarded as the inner border of the outer zone) and the ultrasonic probe.

The timing relationship—especially the time difference—is indicative of the length of the reception path and the transmission paths.

Step 340 may be based on one or more ultrasonic echoes that were reflected from the region of the edge of the outer zone and passed less than twice through the reinforcement cage—thereby ignoring ultrasonic echoes that may have been reflected from the farther regions of the edge of the outer zone.

The transmitted ultrasonic pulses may be of high frequency. High frequency refers to a range that exceeds 200 kHz—for example about 300 kHz. About means up to a deviation of about 20%. Higher resolution requires higher frequency.

Step 330 may also be followed by step 335 of changing the position of the ultrasonic probe within the hole and jumping to step 320. The change of position may include lowering and/or elevating the ultrasonic probe within the hole.

It should be noted that noted that steps 310-240 may be repeated from multiple holes.

This repetition may include using a single ultrasonic probe and positioning it within different holes, one after the other.

Alternatively—this repetition may include concurrently using more than a single ultrasonic probe located within more than a single hole. This concurrent use may require transmitting ultrasonic probes of different frequencies.

Any reference to a system should be applied, mutatis mutandis to a method that is executed by a system and/or to a non-transitory computer readable medium that stores instructions that once executed by the system will cause the system to execute the method. The non-transitory computer readable medium is non-transitory and may be, for example, an integrated circuit, a magnetic memory, an optical memory, a disk, and the like.

Any reference to method should be applied, mutatis mutandis to a system that is configured to execute the method and/or to a non-transitory computer readable medium that stores instructions that once executed by the system will cause the system to execute the method.

Any reference to a non-transitory computer readable medium should be applied, mutatis mutandis to a method that is executed by a system and/or a system that is configured to execute the instructions stored in the computer program product.

The term “and/or” is additionally or alternatively.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

The phrase “may be X” indicates that condition X may be fulfilled. This phrase also suggests that condition X may not be fulfilled. For example—any reference to a system as including a certain component should also cover the scenario in which the system does not include the certain component.

The terms “including”, “comprising”, “having”, “consisting” and “consisting essentially of” are used in an interchangeable manner. For example—any method may include at least the steps included in the figures and/or in the specification, only the steps included in the figures and/or the specification. The same applies to the system and the mobile computer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one as or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Any combination of any component of any component and/or unit of system that is illustrated in any of the figures and/or specification and/or the claims may be provided.

Any combination of any system illustrated in any of the figures and/or specification and/or the claims may be provided.

Any combination of steps, operations and/or methods illustrated in any of the figures and/or specification and/or the claims may be provided.

Any combination of operations illustrated in any of the figures and/or specification and/or the claims may be provided.

Any combination of methods illustrated in any of the figures and/or specification and/or the claims may be provided.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

We claim:

1. A method for measuring an outer zone of a concrete foundation element, the method comprises:
transmitting, by an ultrasonic probe, one or more transmitted ultrasonic pulses towards a region of an edge of the outer zone; wherein the transmission occurs while the ultrasonic probe is located in a hole that is closer to the region of the edge than to a center of the concrete foundation element;
receiving, by the ultrasonic probe, one or more ultrasonic echoes that were reflected from the region of the edge of the outer zone; and
determining a distance between a reinforcement cage of the concrete foundation element and the region of the edge; wherein the determining is based on a spatial relationship between the reinforcement cage and the ultrasonic probe, and timing relationships between the one or more transmitted ultrasonic pulses and the one or more ultrasonic echoes.

2. The method according to claim 1 wherein the transmitted ultrasonic pulses are of high frequency that are not smaller than 200 Khz.

3. The method according to claim 1 wherein the transmitted ultrasonic pulses are of high frequency that are about 300 Khz.

4. The method according to claim 1 wherein the determining is based on one or more ultrasonic echoes that were reflected from the region of the edge of the outer zone and passed less than twice through the reinforcement cage.

5. The method according to claim 1 wherein the hole is formed by an access tube.

6. The method according to claim 1 comprising repeating the transmitting, receiving and determining for different locations of the ultrasonic probe within the hole.

7. The method according to claim 1 comprising repeating the transmitting, receiving and determining for different holes.

8. The method according to claim 1 comprising repeating the transmitting, receiving and determining for different locations of the ultrasonic probe within different holes formed in the concrete foundation element.

9. The method according to claim 1 wherein the ultrasonic pulses are omnidirectional ultrasonic pulses.

10. The method according to claim 1 wherein the ultrasonic pulses are directional ultrasonic pulses.

11. The method according to claim 1 wherein the hole is formed in a conduit that is proximate to a reinforcement cage of the concrete foundation element.

12. The method according to claim 1 wherein the hole is formed in a conduit that is mechanically coupled to a reinforcement cage of the concrete foundation element.

13. The method according to claim 1 wherein the hole is formed in a conduit that located within a reinforcement cage of the concrete foundation element.

14. A non-transitory computer readable medium for measuring an outer zone of a concrete foundation element, the non-transitory computer readable medium stored instructions for:
transmitting, by an ultrasonic probe, one or more transmitted ultrasonic pulses towards a region of an edge of the outer zone; wherein the transmission occurs while the ultrasonic probe is located in a hole that is closer to the region of the edge than to a center of the concrete foundation element;
receiving, by the ultrasonic probe, one or more ultrasonic echoes that were reflected from the region of the edge of the outer zone; and
determining a distance between a reinforcement cage of the concrete foundation element and the region of the edge; wherein the determining is based on a spatial relationship between the reinforcement cage and the ultrasonic probe, and timing relationships between the one or more transmitted ultrasonic pulses and the one or more ultrasonic echoes.

15. The non-transitory computer readable medium according to claim 14 wherein the transmitted ultrasonic pulses are of high frequency that are not smaller than 200 Khz.

16. (canceled)

17. (canceled)

18. The non-transitory computer readable medium according to claim 14 that stores instructions for repeating the transmitting, receiving and determining for different locations of the ultrasonic probe within the hole.

19. The non-transitory computer readable medium according to claim 14 that stores instructions for repeating the transmitting, receiving and determining for different holes.

20. The non-transitory computer readable medium according to claim 14 that stores instructions for repeating the transmitting, receiving and determining for different locations of the ultrasonic probe within different holes formed in the concrete foundation element.

21. The non-transitory computer readable medium according to claim 14 wherein the ultrasonic pulses are omnidirectional ultrasonic pulses.

22. (canceled)

23. A system that comprises a processor and an ultrasonic probe that comprises an ultrasonic transmitter and an ultrasonic receiver;
wherein the ultrasonic probe is configured to transmit one or more transmitted ultrasonic pulses towards a region of an edge of the outer zone; wherein the transmission occurs while the ultrasonic probe is located in a hole that is closer to the region of the edge than to a center of the concrete foundation element;
wherein the ultrasonic probe is configured to receive one or more ultrasonic echoes that were reflected from the region of the edge of the outer zone; and
wherein the processor is configured to participate in determining a distance between a reinforcement cage of the concrete foundation element and the region of the edge; wherein the determining is based on a spatial relationship between the reinforcement cage and the ultrasonic probe, and timing relationships between the one or more transmitted ultrasonic pulses and the one or more ultrasonic echoes.
